(19) United States
(12) Patent Application Publication
(10) Pub. No.: US 2020/0089497 A1
(43) Pub. Date: Mar. 19, 2020

(54) INSTRUCTION SET FOR MINIMIZING CONTROL VARIANCE OVERHEAD IN DATAFLOW ARCHITECTURES

(71) Applicant: QUALCOMM Incorporated, San Diego, CA (US)

(72) Inventors: Rakesh KOMURAVELLI, La Jolla, CA (US); Amin ANSARI, San Diego, CA (US); Ramesh Chandra CHAUHAN, San Diego, CA (US); Karamvir CHATHA, San Diego, CA (US)

(21) Appl. No.: 16/134,945

(22) Filed: Sep. 18, 2018

(51) Int. Cl. G06F 9/30; G06N 5/02

(52) U.S. Cl. CPC G06F 9/30058; G06N 5/02; G06F 9/30029

(57) ABSTRACT

Systems and methods for of minimizing control variance overhead in a dataflow processor include receiving a generating instruction specifying at least an acknowledge predicate based on a first number, a second number, and a first value, wherein a true branch comprises the first number of consumer instructions of the generating instruction based on the first value, used as a first predicate, being true; and a false branch comprises a second number of consumer instructions of the generating instruction based on the first value, used as the first predicate, being false. The acknowledge predicate is evaluated to be a selected number, which is the first number if the first value is true, or the second number if the first value is false. The generating instruction is fired upon the selected number of acknowledge arcs being received from the true branch or the false branch.

### FIELD OF DISCLOSURE

Disclosed aspects are directed to dataflow architectures. More specifically, exemplary aspects are directed to instruction sets with an additional predicate added to instructions for minimizing control variance overhead from variance in acknowledge arcs.

### BACKGROUND

Processing systems which rely on a sequential or pipelined instruction processing model with common memory structures such as a global memory, centralized register, etc., wherein different processing elements may interact by reading input data from and/or writing output data to the common memory structures. Computer architectures, such as the well-known reduced instruction set computer (RISC), employ the above instruction processing model, which involves centralized control for coordinating operations between the different processing elements (e.g., execution units) for parallel processing, resources and latencies associated with sending messages back and forth between the common memory structures. This traditional model may also be referred to as a control flow model to distinguish from a dataflow model which will now be discussed.

To address some of the above limitations of conventional processing systems, dataflow architectures have been developed, wherein processing elements are provisioned such that processing of instructions is commenced or “fired” as soon as the data values on which the instructions depend become available. In the dataflow model, the processing elements may be interconnected by a packet routing network that allows processing elements to send packets or data directly to other processing elements, eliminating the need for writing to/reading from common memory structures as previously explained. For example, hardware solutions may be provided for delivering a producer or generating instruction's output data directly as input data to one or more consumer instructions, without the involvement of a register file. The instructions may execute in a dataflow order, with each instruction firing when all of its inputs are available. The dataflow approach also eliminates the use of a program counter which is seen in the traditional control flow model. In the dataflow model, the data dependencies of a group or block of instructions determine the sequence in which the instructions are carried out.

Dataflow architectures may employ compilers to generate the instruction set architecture (ISA) for the dataflow architectures in the form of dataflow graphs, which may eliminate the burden in hardware to discover and handle data dependencies at runtime. A dataflow graph may be viewed in terms of instructions being represented as nodes and directed arcs representing data dependencies between the instructions. Each instruction may have one or more input operands and generate at least one output. The at least one output of an instruction, say, a generating instruction or producer, may be consumed by one or more consumer instructions. The generating instruction fires when all of its input operands have been received, and expects an acknowledge arc from each consumer of the at least one output.

Generating instructions which are conditional instructions are implemented using predicates in the dataflow model. For example, an output of the generating instruction may be consumed by a first set of instructions if a predicate evaluates to true, while the output may be consumed by a second set of instructions if the predicate evaluates to false. The predicate is treated as another operand of the generating instruction. Consumer instructions of the predicated instruction may be divided into two branches, a true branch comprising consumer instructions based on the predicate evaluating to true, and a false branch comprising consumer instructions based on the predicate evaluating to false. In conventional implementations of dataflow architectures, the generating instruction waits for acknowledge arcs from all consumer instructions, including the consumer instructions in the true branch as well as the consumer instructions in the false branch.

To reduce the number of acknowledge arcs, a known optimization involves balancing the number of consumer instructions in the two branches. In cases wherein the two branches do not comprise the same number of consumer instructions, a number of null/dummy instructions or identity operations (which do not produce meaningful results) are added to pad the branch comprising the lower number of consumer instructions, in order to equalize the number of consumer instructions in both branches. In this manner, the number of acknowledge arcs from both branches would also be made equal. Since the predicate may evaluate to only one of the two values, true or false, each of which would then lead to the same number of acknowledge arcs to be received from the corresponding branch, acknowledge arcs from only one of the two branches may be used in firing the conditional instruction. For example, the generating instruction may fire when the acknowledge arcs from all of the consumer instructions in the true branch alone (which would be of equal number as the acknowledge arcs in the false branch) are received. Although this optimization potentially reduces the number of acknowledge arcs for the generating instruction's firing, it adds the costs associated with scheduling and executing the additional identity instructions which may be added to one of the two branches.

There is, accordingly, a corresponding need in the art to efficiently handle generating instructions which have varying numbers of consumer instructions in the different branches based on a predicate value.

### SUMMARY

Exemplary aspects of the invention are directed to systems and methods for minimizing control variance overhead in dataflow architectures. For example, an exemplary additional predicate may be added to dataflow instructions for minimizing control variance overhead from variance in acknowledge arcs.

For example, an exemplary aspect is directed to a method of instruction processing. The method comprises receiving a generating instruction in a dataflow processor, the generating instruction specifying at least an acknowledge predicate based on a first number, a second number, and a first value, wherein a true branch comprises the first number of consumer instructions of the generating instruction based on the first value, used as a first predicate, being true; and a false branch comprises a second number of consumer instructions of the generating instruction based on the first value, used as the first predicate, being false. The method further comprises evaluating the acknowledge predicate to be a selected number, wherein the selected number is the first number if the first value is true, or the second number if the first value is false, and firing the generating instruction when the selected number of acknowledge arcs are received from the true branch or the false branch, based on whether the first value is true or false, respectively.

Another exemplary aspect is directed to an apparatus comprising a dataflow processor. The dataflow processor comprises an execution engine configured to execute instructions, the instructions comprising at least a generating instruction specifying at least an acknowledge predicate based on a first number, a second number, and a first value, wherein a true branch comprises the first number of consumer instructions of the generating instruction based on the first value, used as a first predicate, being true; and a false branch comprises a second number of consumer instructions of the generating instruction based on the first value, used as the first predicate, being false. The dataflow processor further comprises an enablement block configured to: evaluate the acknowledge predicate to be a selected number, wherein the selected number is the first number if the first value is true, or the second number if the first value is false, and fire the generating instruction when the selected number of acknowledge arcs are received from the true branch or the false branch, based on whether the first value is true or false, respectively.

Another exemplary aspect is directed to a non-transitory computer-readable storage medium comprising code, wherein the code comprises: a generating instruction to be executed in a processor, the generating instruction specifying at least an acknowledge predicate based on a first number, a second number, and a first value, wherein a true branch comprises the first number of consumer instructions of the generating instruction based on the first value, used as a first predicate, being true; and a false branch comprises a second number of consumer instructions of the generating instruction based on the first value, used as the first predicate, being false; code for evaluating the acknowledge predicate to be a selected number, wherein the selected number is the first number if the first value is true, or the second number if the first value is false; and code for firing the generating instruction when the selected number of acknowledge arcs are received from the true branch or the false branch, based on whether the first value is true or false, respectively.

Yet another exemplary aspect is directed to an apparatus comprising means for executing instructions in a dataflow processor, the instructions comprising at least a generating instruction specifying at least an acknowledge predicate based on a first number, a second number, and a first value, wherein a true branch comprises the first number of consumer instructions of the generating instruction based on the first value, used as a first predicate, being true; and a false branch comprises a second number of consumer instructions of the generating instruction based on the first value, used as the first predicate, being false. The apparatus further comprises means for evaluating the acknowledge predicate to be a selected number, wherein the selected number is the first number if the first value is true, or the second number if the first value is false, and means for firing the generating instruction when the selected number of acknowledge arcs are received from the true branch or the false branch, based on whether the first value is true or false, respectively.

### BRIEF DESCRIPTION OF THE DRAWINGS

The accompanying drawings are presented to aid in the description of aspects of the invention and are provided solely for illustration of the aspects and not limitation thereof.

FIG. 1 illustrates a conventional implementation of a conditional instruction in a dataflow machine.

FIG. 2 illustrates an exemplary dataflow machine with a generating instruction comprising an acknowledge predicate, according to aspects of this disclosure.

FIG. 3 illustrates an exemplary pseudo code embodying aspects of this disclosure.

FIG. 4 illustrates an example dataflow architecture configured to implement exemplary aspects of this disclosure.

FIG. 5 illustrates an exemplary method of operating a dataflow machine, according to aspects of this disclosure.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer-readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Exemplary aspects of this disclosure are directed to dataflow machines, and more specifically, static dataflow machines in some aspects. Variances in a number of acknowledge arcs for producers or generating instructions may be captured within the generating instructions themselves, in aspects of this disclosure. In more detail, a generating instruction may be a conditional instruction wherein the condition is expressed using a predicate. For instance, a generated output of the generating instruction may be consumed by a first set of consumer instructions having a true value of the predicate as an input; and by a second set of instructions having a complement or false value of the predicate as an input. The generating instruction may thus have a first number of consumer instructions in a true branch based on the predicate, referred to hereafter as a first predicate, evaluating to true and a second number of consumer instructions in the false branch based on the first predicate evaluating to false. While the generating instruction can receive both a first number of acknowledge arcs from the first number of consumer instructions in the true branch, and a second number of acknowledge arcs from the second number of consumer instructions in the false branch, the actual number of acknowledge arcs that the generating instruction receives is reduced to either the first number or the second number, according to aspects described herein.

A new field referred to herein as an “acknowledge predicate” is added to the generating instruction to determine a selected number of acknowledge arcs, the selected number being one of the first number of acknowledge arcs or the second number of acknowledge arcs. The generating instruction may fire upon receiving the selected number. The selected number is based on whether the first predicate evaluates to true or false. In this manner, variations in the first number and the second number may be handled in the generating instruction. Overheads such as those associated with identity operations may be avoided.

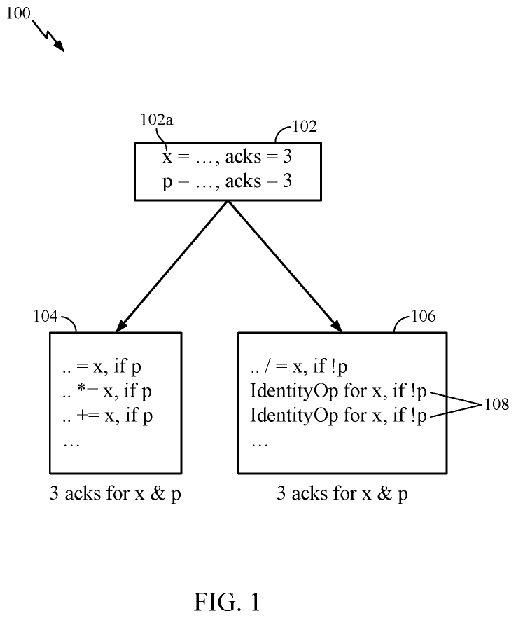

With reference first to FIG. 1, generating instruction execution in a conventional dataflow machine 100 is shown. A block of instructions 102 comprising generating instruction 102a may be implemented with the use of a predicate, shown as the value “p”, and hereinafter referred to as the first predicate. The first predicate p is considered as one of the outputs of generating instruction 102a, with true branch 104 comprising three (3) consumer instructions of the output “x” of the generating instruction 102a based on first predicate p being true, and false branch 106 comprising one (1) consumer instruction of the output “x” of generating instruction 102a based on first predicate p being false. In this case, three (3) acknowledge arcs would be provided from true branch 104 and one acknowledge arc would be provided from false branch 106. As previously explained, in order to reduce the number of acknowledge arcs, two (2) identity operations 108 are added to false branch 106 to equalize the number of consumer instructions in true branch 104 and false branch 106, thus bringing the number of acknowledge arcs from both branches to three (3).

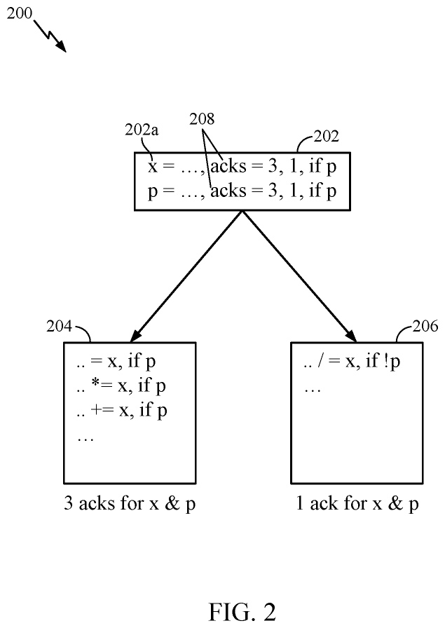

FIG. 2 illustrates improvements over the above-described conventional techniques. Specifically, exemplary dataflow machine 200 is shown with instruction block 202 comprising generating instruction 202a which includes an acknowledge predicate 208, “acks=3, 1, if p”, based on a first number “3”, a second number “1” and a first value “p”. Acknowledge predicate 208 is distinguished from the first predicate upon which generating instruction 102a of FIG. 1 was predicated. It is noted that the first value p remains one of the outputs of instruction block 202, and is used as a predicate, or more specifically, the first predicate for the consumers of the output of generating instruction 202a, i.e., “x”. In this case, true branch 204 comprises three (3) consumer instructions of the output “x” of generating instruction 202a based on the first value p used as the first predicate being true, and false branch 206 comprises one (1) consumer instruction of the output “x” of generating instruction 202a based on the first value p used as the first predicate being false.

However, departing from conventional implementations, acknowledge predicate 208 is configured to select between the first number of acknowledge arcs to be expected based on the first value p evaluating to true and the second number of acknowledge arcs to be expected based on the first value p evaluating to false. The nomenclature, “acknowledge predicate=first number, second number, if first value p” is an exemplary manner of describing the function of acknowledge predicate, to select the first number if the first value p is true, or the second number if the first value p is false.

Based on the inclusion of the acknowledge predicate 208 in generating instruction 202a, the selected number of acknowledge arcs that are to be expected by generating instruction 202a is known in generating instruction 202a itself, based on the first value p. It is noted that the first value “p” may be an operand or output of an instruction which is generated before “x” is generated, so the first value “p” may be referenced in generating instruction 202a. Subsequently, generating instruction 202a need only wait for the selected number of acknowledge arcs from the corresponding true branch 204 or false branch 206 before firing. In other words, generating instruction 202a need not wait for the sum of all acknowledge arcs from both branches, i.e., the sum of the first number and the second number. Furthermore, identity operations (such as identity operations 108) need not be added to equalize the first number and the second number in case they are not already equal. Accordingly, as seen in the example of FIG. 2, based on the first value p evaluating to true, acknowledge predicate 208 will select the first number (e.g., “3” in this case) and generating instruction 202a would receive the first number (i.e., “3”) acknowledge arcs from true branch 204; or based on the first value p evaluating to false, acknowledge predicate 208 will select the second number (e.g., “1” in this case) and generating instruction 202a would receive the second number (i.e., “1”) acknowledge arc from false branch 206.

As seen from the above improvements, the number of acknowledge arcs to be sent to generating instruction 202a from its branches 204, 206 may be reduced in exemplary aspects. Although the numerical examples of the first number being “3” and the second number being “1” have been used merely for the sake of illustration, in real world examples of dataflow machine implementations, these numbers may be significantly larger (in the order of hundreds or thousands of instructions in each branch), and thus, the savings from avoiding unnecessary acknowledge arcs would also increase concomitantly. Continuing to refer to the illustrated example of FIG. 2, avoiding two identity operations to pad the second number (1) to equal the first number (3) reduces associated scheduling and execution costs. Furthermore, avoiding the related acknowledge arcs from such identity operations or from the unselected one of the taken/not-taken branches also translates to saving the associated costs of creating and forwarding corresponding data packets containing the acknowledge arcs.

Additional savings in cost may also be realized in particular cases, such as when acknowledge predicate 208 evaluates to a value of “0” (i.e., the selected one of the first number or the second number, based on the first value p being true or false, respectively, is “0”). This means that generating instruction 202a is to wait on “0” acknowledge arcs from consumer instructions of the respective one of the true branch 204 or false branch 206. In other words, generating instruction 202a need not wait for any acknowledge arcs since no consumer instructions will be consuming the output (i.e., “x”) of generating instruction 202a. Since no consumer instructions will be consuming the output x, generating the output x may be altogether avoided. Accordingly, in exemplary implementations, if acknowledge predicate 208 evaluates to “0” or leads to the selection of zero acknowledge arcs, then execution of operations to generate the output x may be curtailed and no valid output may be generated. By implementing techniques to selectively avoid needless computations when no valid output is to be generated in such situations, power savings may be realized.

In exemplary aspects, the inclusion of acknowledge predicate 208 in generating instruction 202a may be implemented using a change in the instruction set architecture (ISA) of dataflow machine 200. Although not separately illustrated, a compiler of instructions for dataflow machine 200 may provide the dataflow graphs for executing instructions based on the changed ISA, taking into account such acknowledge predicates for conditional instructions.

In addition to the acknowledge predicate noted above, it will be understood that other predicates may also be associated with the generating instruction, without affecting the scope of this disclosure. For instance, generating instruction 202a may itself belong to a branch (e.g., a true branch or a false branch) of a predecessor instruction of generating instruction 202a, wherein the predecessor instruction may be a conditional instruction implemented using a second value, e.g., “q” as a predicate. In such a case, generating instruction 202a may be a consumer based on the second value q used as a predicate, or more specifically the first predicate for the generating instruction 202a. For example, if generating instruction 202a is in one of the true branch 204 or the false branch 206 of the predecessor instruction, then generating instruction 202a may receive the second value q used as the first predicate, as another input operand. However, this second value q used as the first predicate for the generating instruction 202a, if it exists in appropriate cases, does not affect the scope of the above discussion.

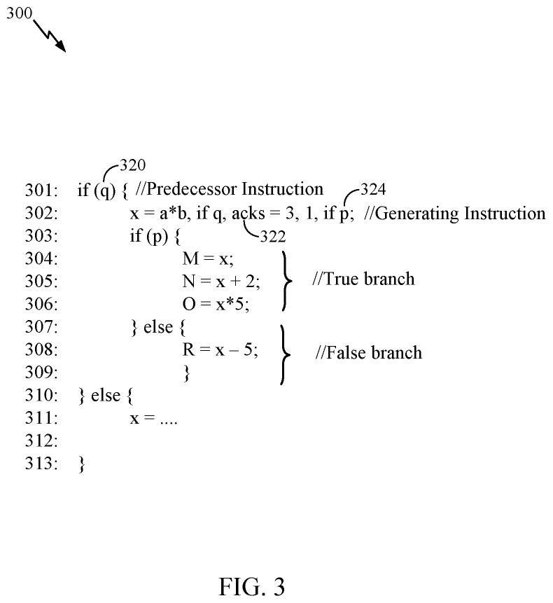

The above aspects are further explained with reference to pseudo code 300 shown in FIG. 3. Pseudo code 300 may correspond to an instruction sequence which may be executed by exemplary dataflow machine 200 of FIG. 2. Line numbers 301-313 have been indicated for ease of reference to the corresponding lines of code. Accordingly, at line 301, a predecessor instruction is shown as noted above, which may include a second value q and designated with the reference numeral 320. As will be explained further below, the second value q in line 301 is a predicate for a generating instruction, and referred to as the first predicate of the generating instruction to distinguish it from the acknowledge predicate of the generating instruction, as will now be described.

Line 302 shows the generating instruction, e.g., the above-noted generating instruction 202a, in the true branch of the predecessor instruction in line 301, whose output would be valid if the first predicate q 301 is true. The generating instruction in line 302 may generate an output “x”, and may be a conditional instruction expressed using acknowledge predicate 322 “acks=3, 1, if p”, with the first value p in this case designated with the reference numeral 324. The first value p 324 is the predicate for consumers of the generating instruction's output x. In more detail, on lines 303-306 are shown consumer instructions M, N, and O which consume “x” based on the first value p being used as first predicate p 324 evaluating to true, on the true branch, and may provide a corresponding first number of three (3) acknowledge arcs to the generating instruction. On lines 307-309, consumer instruction R is illustrated, which consumes “x” based on the first value p being used as the first predicate p 324 evaluating to false, on the false branch, and may provide a corresponding second number of one (1) acknowledge arc to the generating instruction. Lines 310-313 representatively show a false branch of the predecessor instruction, but are not particularly relevant to this discussion and so will not be described in further detail.

To capture the variance between the first number and the second number, acknowledge predicate 322, discussed above, is provided in the generating instruction. The acknowledge predicate 322 is used to select between the first number “3” or the second number “1” based on the first value p 324 (notwithstanding any other predicate such as the first predicate q 320 that may be provided as an input to the generating instruction). Accordingly, the generating instruction need only wait on the selected number of acknowledge arcs between the first number and the second number, avoiding, for example, the need for identity operations to be added to the false branch on lines 307-309. Further, if, for example, the selected number is “0” in some cases, then a valid output value of x need not be generated.

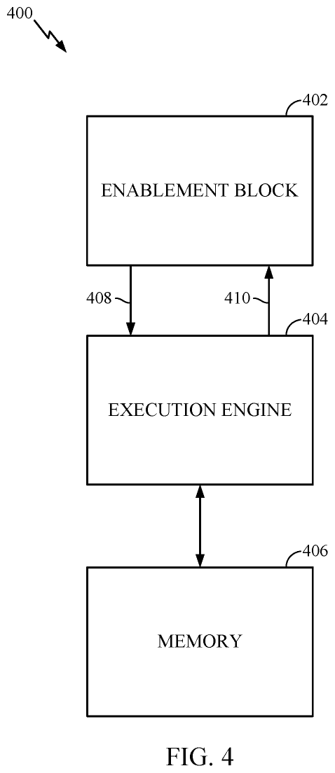

With reference now to FIG. 4, processing system 400 is shown, wherein processing system 400 may be configured as a dataflow machine to support exemplary aspects of this disclosure. In general, processing system 400 is configured to support directed producer-consumer pairs of instructions which are related by functional dependencies. A producer or generating instruction may have one or more consumer instructions, and a consumer instruction may have one or more producer instructions. Instructions in block 202 and consumer instructions in true branch 204 and false branch 206 (as well as instructions in pseudo code 300) are examples of instructions which may be processed in processing system 400. Enablement block 402 and execution engine 404 may in combination represent processing elements which may be used in execution of the instructions in processing system 400. Among other interconnections between enablement block 402 and execution engine 404 which may be present, enable/fire commands 408 and acknowledge arcs 410 are separately shown. Execution engine 404 may execute instructions when all operands are ready. Enablement block 402 may resolve dependencies based on acknowledge arcs 410 and provide enable/fire commands 408 to trigger respective instruction executions. Memory 406 may be configured to store instructions and/or data for backup storage.

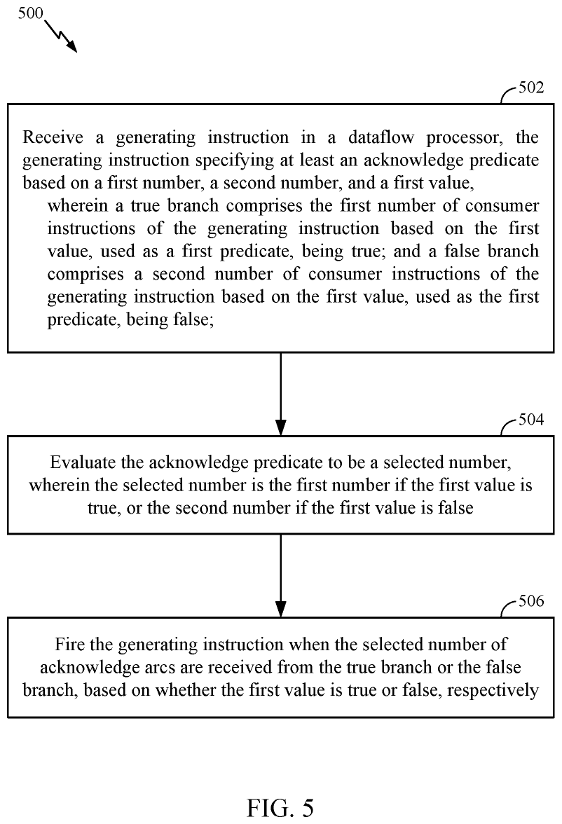

It will be appreciated that exemplary aspects include various methods for performing the processes, functions and/or algorithms disclosed herein. For example, FIG. 5 (with combined references to FIGS. 2-4) illustrates a method 500 of instruction processing in a dataflow processor (such as processing system 400).

Block 502 comprises receiving a generating instruction (e.g., generating instruction 202a) in a dataflow processor (e.g., dataflow machines 200/400), the generating instruction specifying at least an acknowledge predicate (e.g., acknowledge predicate 322) based on a first number, a second number, and a first value, wherein a true branch (e.g., true branch 204) comprises the first number (e.g., “3”) of consumer instructions of the generating instruction based on the first value used as a first predicate being true, and a false branch (e.g., false branch 206) comprises the second number (e.g., “1”) of consumer instructions of the generating instruction based on the first value used as the first predicate being false.

Block 504 comprises evaluating the acknowledge predicate to be a selected number, wherein the selected number is the first number if the first value is true, or the second number if the first value is false.

Block 506 comprises firing the generating instruction when the selected number of acknowledge arcs are received from the true branch or the false branch, based on whether the first value is true or false, respectively (e.g., without requiring the sum of the first number and the second number of acknowledge arcs or without padding one of the branches with identity operations).

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer-readable media embodying a method for minimizing control variance overhead in dataflow machines. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of instruction processing, the method comprising:
receiving a generating instruction in a dataflow processor, the generating instruction specifying at least an acknowledge predicate based on a first number, a second number, and a first value,
wherein a true branch comprises the first number of consumer instructions of the generating instruction based on the first value, used as a first predicate, being true; and a false branch comprises a second number of consumer instructions of the generating instruction based on the first value, used as the first predicate, being false;
evaluating the acknowledge predicate to be a selected number, wherein the selected number is the first number if the first value is true, or the second number if the first value is false; and
firing the generating instruction when the selected number of acknowledge arcs are received from the true branch or the false branch, based on whether the first value is true or false, respectively.

2. The method of claim 1, comprising generating a valid output operand in the generating instruction if the selected number is non-zero.

3. The method of claim 1, further comprising generating a non-valid output operand in the generating instruction if the selected number is zero.

4. The method of claim 1, wherein the generating instruction is based on a second value used as a first predicate of the generating instruction, the generating instruction being in a true branch or a false branch of a predecessor instruction specifying the second value, if the second value is true or false, respectively.

5. The method of claim 1, wherein the dataflow processor is a static dataflow processor.

6. An apparatus comprising:
a dataflow processor comprising:
an execution engine configured to execute instructions, the instructions comprising at least a generating instruction specifying at least an acknowledge predicate based on a first number, a second number, and a first value,
wherein a true branch comprises the first number of consumer instructions of the generating instruction based on the first value, used as a first predicate, being true; and a false branch comprises a second number of consumer instructions of the generating instruction based on the first value, used as the first predicate, being false; and
an enablement block configured to:
evaluate the acknowledge predicate to be a selected number, wherein the selected number is the first number if the first value is true, or the second number if the first value is false; and
fire the generating instruction when the selected number of acknowledge arcs are received from the true branch or the false branch, based on whether the first value is true or false, respectively.

7. The apparatus of claim 6, wherein the execution engine is configured to generate a valid output operand in the generating instruction if the selected number is non-zero.

8. The apparatus of claim 6, wherein the execution engine is configured to generate a non-valid output operand in the generating instruction if the selected number is zero.

9. The apparatus of claim 6, wherein the generating instruction is based on a second value used as a first predicate of the generating instruction, the generating instruction being in a true branch or a false branch of a predecessor instruction specifying the second value, if the second value is true or false, respectively.

10. The apparatus of claim 6, wherein the dataflow processor is a static dataflow processor.

11. A non-transitory computer-readable storage medium comprising code, wherein the code comprises:
a generating instruction to be executed in a processor, the generating instruction specifying at least an acknowledge predicate based on a first number, a second number, and a first value,
wherein a true branch comprises the first number of consumer instructions of the generating instruction based on the first value, used as a first predicate, being true; and a false branch comprises a second number of consumer instructions of the generating instruction based on the first value, used as the first predicate, being false;
code for evaluating the acknowledge predicate to be a selected number, wherein the selected number is the first number if the first value is true, or the second number if the first value is false; and
code for firing the generating instruction when the selected number of acknowledge arcs are received from the true branch or the false branch, based on whether the first value is true or false, respectively.

12. The non-transitory computer-readable storage medium of claim 11, comprising code for generating a valid output operand in the generating instruction if the selected number is non-zero.

13. The non-transitory computer-readable storage medium of claim 11, further comprising code for generating a non-valid output operand in the generating instruction if the selected number is zero.

14. The non-transitory computer-readable storage medium of claim 11, wherein the generating instruction is based on a second value used as a first predicate of the generating instruction, the generating instruction being in a true branch or a false branch of a predecessor instruction specifying the second value, if the second value is true or false, respectively.

15. An apparatus comprising:
means for executing instructions in a dataflow processor, the instructions comprising at least a generating instruction specifying at least an acknowledge predicate based on a first number, a second number, and a first value,
wherein a true branch comprises the first number of consumer instructions of the generating instruction based on the first value, used as a first predicate, being true; and a false branch comprises a second number of consumer instructions of the generating instruction based on the first value, used as the first predicate, being false; and
means for evaluating the acknowledge predicate to be a selected number, wherein the selected number is the first number if the first value is true, or the second number if the first value is false; and
means for firing the generating instruction when the selected number of acknowledge arcs are received from the true branch or the false branch, based on whether the first value is true or false, respectively.

16. The apparatus of claim 15, wherein the means for executing instructions comprises means for generating a valid output operand in the generating instruction if the selected number is non-zero.

17. The apparatus of claim 15, wherein the means for executing instructions comprises means for generating a non-valid output operand in the generating instruction if the selected number is zero.
